(19) United States
(12) Patent Application Publication
(10) Pub. No.: US 2007/0143617 A1
(43) Pub. Date: Jun. 21, 2007

(54) Method for embedding and detecting a watermark in a digital audio signal

(76) Inventors: Nikolaus Farber, Erlangen (DE); Frank Hartung, Herzogenrath (DE)

Correspondence Address: ERICSSON INC., 6300 LEGACY DRIVE, M/S EVR 1-C-11, PLANO, TX, 75024, US

(21) Appl. No.: 10/546,083

(22) PCT Filed: Feb. 21, 2003
(86) PCT No.: PCT/EP03/01778

§ 371 Date: Dec. 18, 2006

(51) Int. Cl. H04L 9/00

(52) U.S. Cl. 713/176

(57) ABSTRACT

The invention relates to a method for embedding and detecting a watermark in a digital audio signal. For embedding the watermark in the digital audio signal a modified-segment (Sₒᵤₜ^{(t)}) is created from a selected input-segment (sᵢₙ^{(t)}) of the digital audio signal. The modified-segment (sₒᵤₜ^{(t)}) is created such, that at least one of two sub-segments ((s_{sub}, 1^{(t)}(s_{sub}, 2^{(t)}) of the input-segment (sᵢₙ^{(t)}) is time-shifted (dt) such that in an overlapping zone (Lₒᵥ) a correlation value of the two sub-segments (s_{sub}, 1^{(t)}, (s_{sub}, 2^{(t)}) is a maximum. The signal (sₒᵥ(t)) in the overlapping zone (Lₒᵥ) is then created as a weighted average of the two sub-segments ((s_{sub}, 1^{(t)}, (s_{sub}, 2^{(t)}) in said overlapping zone. For detecting the embedded watermark in a received digital audio signal (x(t)), a first template-signal (h1 (t)) and a second template-signal (h2(t)) are generated. Then a first (c1) and a second (c2) correlation value are created by comparing the first (h1(t)) and second (h2(t)) template-signal with the received digital audio signal (x(t)). Finally, it is assumed that a watermark is included in the received digital audio signal, if the second correlation value (c2) is higher than the first correlation value (c1).

This invention relates to a method for embedding and detecting a watermark in a digital audio signal.

It is state of the art to use watermarks in digital rights management for digital media such as video or audio. A watermark is a digital information, which is hidden in the media or host data, such that it is ideally imperceptible but not removable. Hence, it can be used to attach information about the origin, owner, and status of the media. This information can then be used e.g. to trace back the origin of an illegal copy.

The most commonly used technique to embed a watermark into a signal is based on an idea from spread-spectrum radio communications. Here, the embedded watermark is created when a pseudorandom noise sequence with low amplitude is added to the original signal. This added sequence, can then be detected at a later stage with e.g. a correlation receiver or a matched filter. If the parameters of the added sequence, like the amplitude or the sequence length are chosen appropriately, the probability of the detection is very high. If several of such watermarks are embedded consecutively, several bits of information can be conveyed. In general, the higher the number of samples used to embed one bit and the higher the amplitude of the added sequence, the more robust is the watermark against attacks. On the other hand, the watermark becomes audible, when the amplitude is too high and the amount of embedded information is reduced, when the number of samples increases. Hence, there exists a trade-off between robustness, watermark data-rate, and quality.

Watermarking techniques, which are based on the spread-spectrum approach, require a rather strict synchronization. If such a synchronization is not maintained, then the detection of embedded information will not be possible anymore. Therefore, synchronization is often considered to be a pre-requirement in prior art solutions.

But exactly this weakness is exploited by so called synchronization attacks, which attempt to break the correlation and make the recovery of the watermark impossible or infeasible. Such attacks can be geometric manipulations, like e.g. zoom, rotation, shearing, cropping, and re-sampling. For audio, known manipulations are the insertion or deletion of single audio samples, like e.g. a jitter attack, sample rate conversion like e.g. linear time-scaling, the extension or shortening of speech pauses, or the pitch-shifting. Since a typical watermark detector has to know the exact position of the embedded data, these attacks are very effective and thus a major problem in the practical application of watermarks in audio signals.

It is therefore an object of the present invention to overcome the above mentioned problems and to provide a method for embedding a watermark in a digital audio signal, where the digital audio signal, which includes several pitch periods and is divided into groups of N samples, comprising the steps of selecting from one of the groups of N samples an input-segment with an input-length, dividing the input-segment into at least two sub-segments, each sub-segment having a length of at least one pitch period, creating a modified-segment with an output-length, wherein at least one of the sub-segments is time-shifted such that in an overlapping zone a correlation value of the two sub-segments is a maximum, and wherein the signal in the overlapping zone is a weighted average of the two sub-segments in said overlapping zone.

Further there is provided a method for detecting a watermark in a received digital audio signal, where the received digital audio signal may include at least one modified-segment, which is modified according to the above embedding method, and comprising the steps of receiving for said at least one modified-segment an a-priori information about: the input-segment, the modified-segment, extension-segments and a start point of that modified-segment; generating a first template-signal, which is the input-segment with the extension-segments before and after the input-segment; generating a second template-signal, which is the modified-segment with the extension-segments before and after the modified-segment; creating a first and a second correlation value by comparing the first and second template-signal with the received digital audio signal, and assuming that a watermark is included, if the second correlation value is higher than the first correlation value.

With it, an embedded watermark is more resistant against synchronization attacks, because the watermark is generated in the same manner as such an attack. Any kind of synchronization attack, which is applied before or after the extension-segments, does not degrade the performance of the proposed detection method. Although any known method for detecting a watermark will benefit from the a-priori knowledge of the original signal, the proposed method takes as a direct advantage from this pre-requirement, a higher robustness against synchronization attack.

If the time-shift from said at least one of the sub-segments is equal to a pitch period, the transition between the modified-segment and the neighboring signal-segments is smooth and thus the embedded watermark is less audible.

A further time-shift, from said at least one of the sub-segments, which is equal to a multiple number of the pitch periods, causes a higher difference between the input-length form the input segment and the output-length from the modified segment. Thus the following detection of the embedded watermark in a digital audio signal will become easier, because the difference between the input-segment and the modified-segment is more distinguishable.

If the input-segment is selected from one of the groups of N samples, where consecutive pitch periods are similar, the embedding is less audible. Then, the resulting signal in the overlapping zone, which is a weighted average of the overlapping sub-segments, varies only slightly from these pitch periods before and after the overlapping zone. This causes that the modification is less audible.

Selecting the input-segment from the mid of one of the groups of N samples or depending on a pre-defined secret key, causes that the start point of the modified segment is known, which simplifies the following detection method.

If the principle of the present embedding method is repeated for several input-segments, where the output-length from each of the respective modified-segments is different, a higher modulation level can be achieved and thus more information can be included in the modified digital audio signal. Then, according to the number of different modified-segments, a corresponding number of different template signals for the detection method have to be generated.

If the length of the extension-segments is in the range from 10 ms to 40 ms, it is supposed that within that range the audio signal is approximately stationary. Hence, the template-signals are distinguishable and detection is always robust enough.

Further features and advantages of the present invention will be apparent to those skilled in the art from further dependent claims and the following detailed description, taken together with the accompanying figures, where:

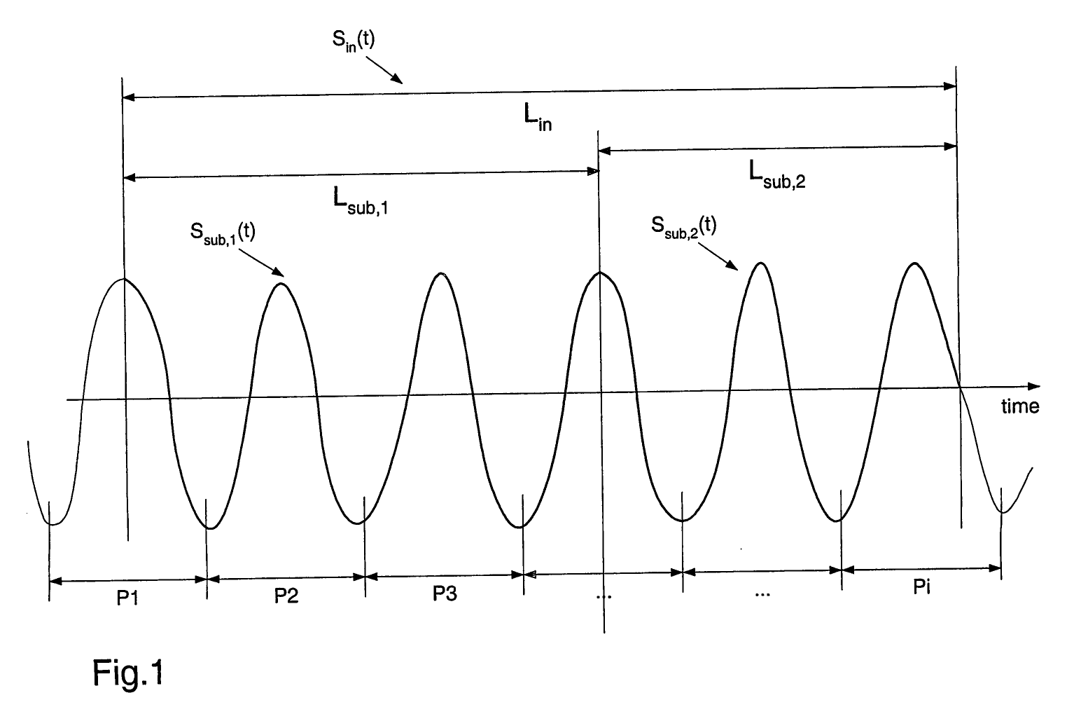

FIG. 1 shows an input-segment with a first and second sub-segment according to a first embodiment;

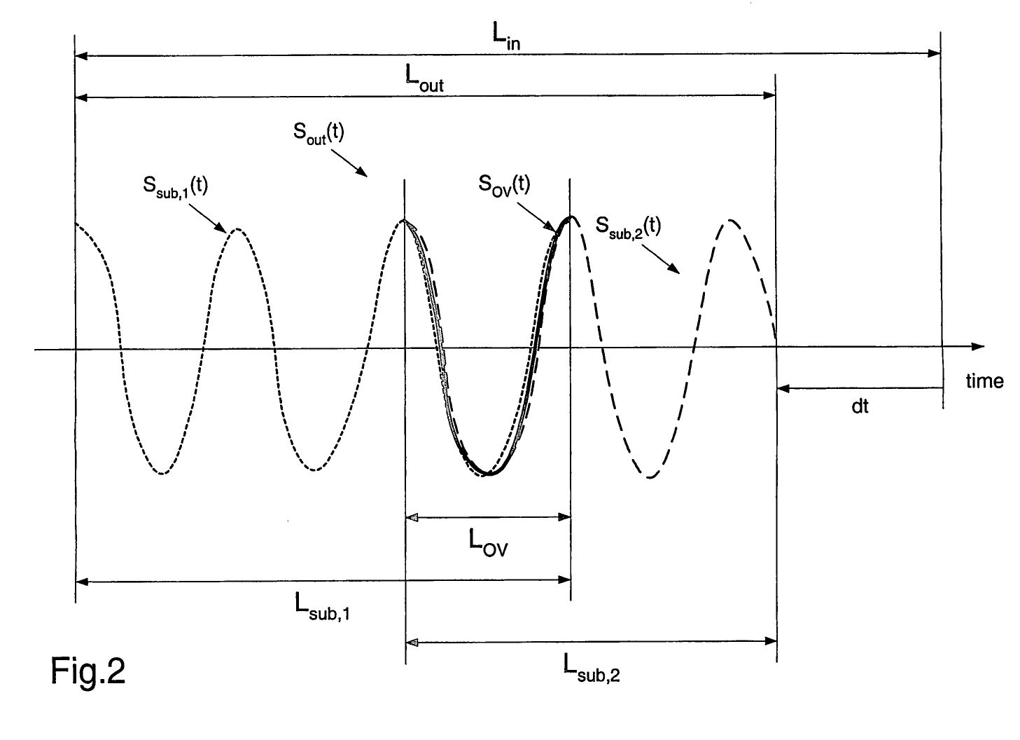

FIG. 2 shows an output-segment according to the first embodiment;

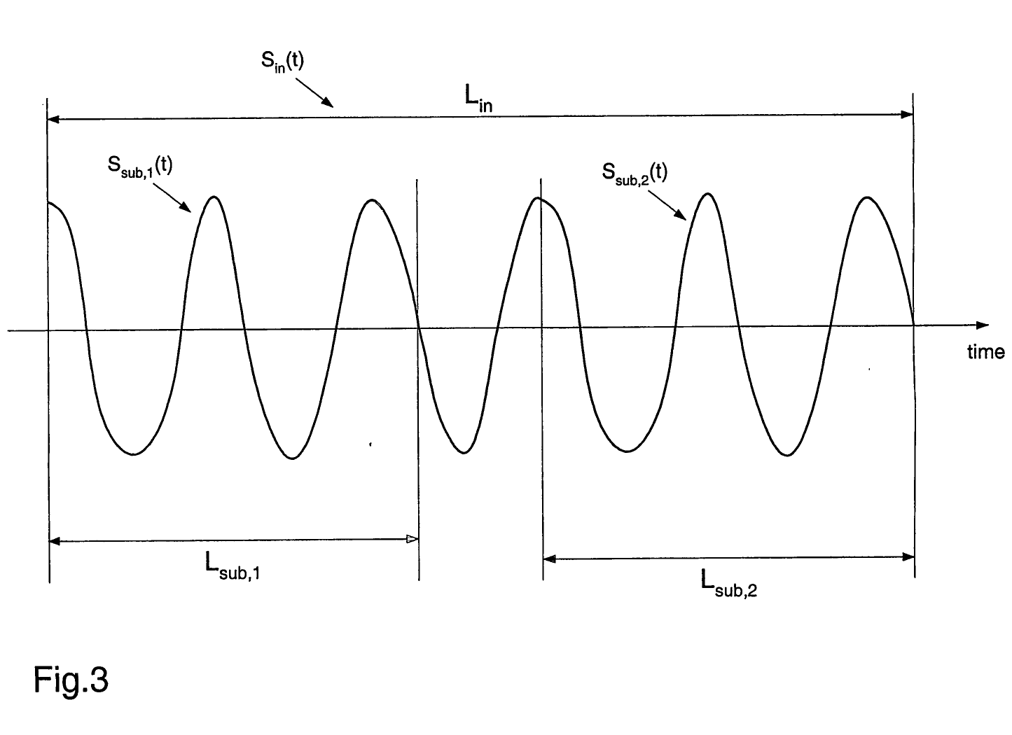

FIG. 3 shows an input-segment with a first and second sub-segment according to a second embodiment;

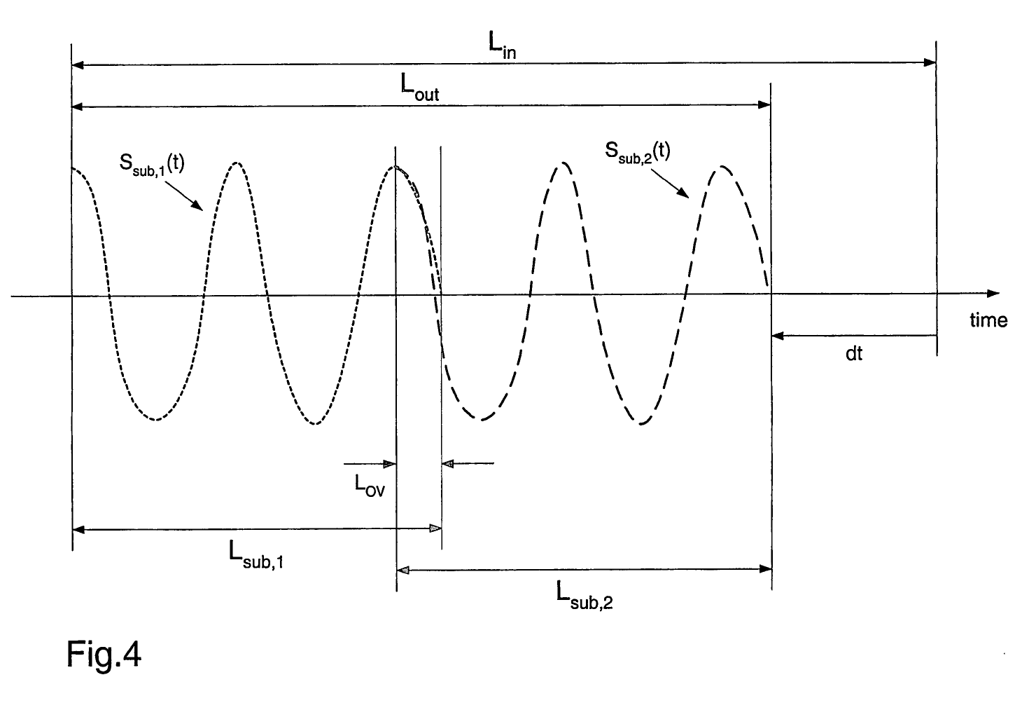

FIG. 4 shows an output-segment according to the second embodiment;

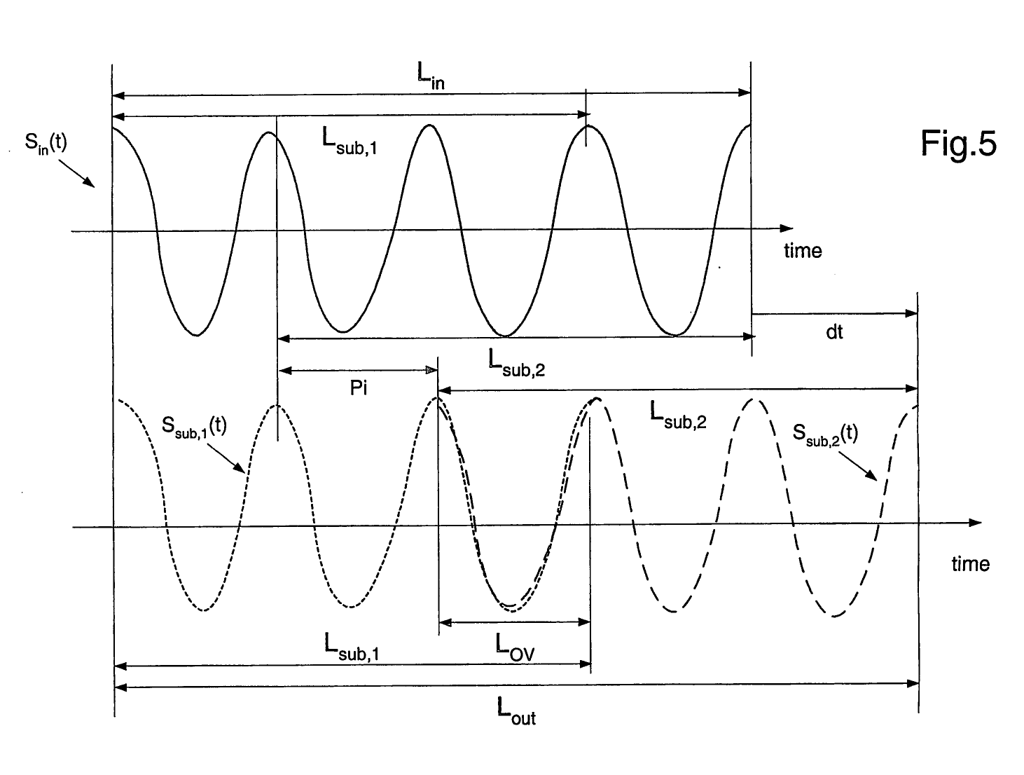

FIG. 5 shows an input- and an output-segment according to a further embodiment;

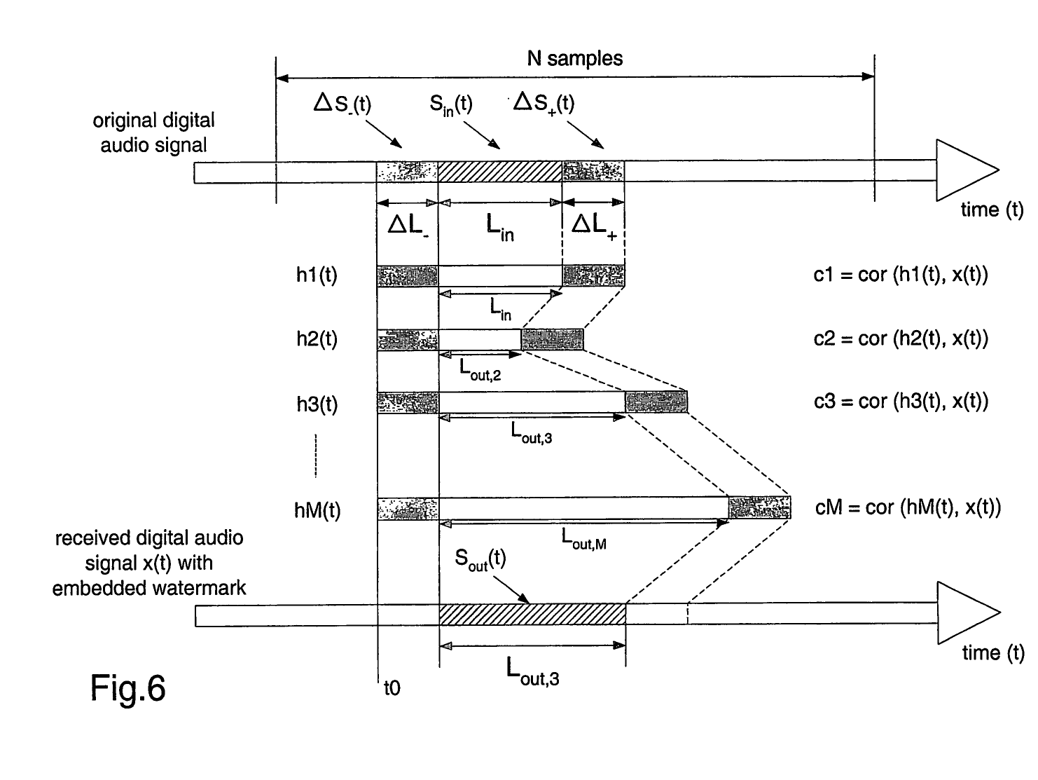

FIG. 6 shows template-signals for the detection of a watermark in a digital audio signal.

In the time domain, digital audio signals are divided into groups of N samples. This is already known to those skilled in the art and thus not described in more detail. The embedding and detecting method according to the present invention applies to parts of such groups of N samples. FIG. 1 shows an input-segment sᵢₙ(t), which is selected from one of the groups of N samples from the digital audio signal. The digital audio signal having a number of consecutive pitch periods P1, P2, P3, . . . , Pi, each characterizing a part of the input-segment sᵢₙ(t) with a similar waveform.

The input-segment sᵢₙ(t), with a length Lᵢₙ, is divided into two sub-segments s_{sub,1}(t) and s_{sub,2}(t), with a respective length L_{sub,1} and L_{sub,2} respectively. Each of the sub-segments, s_{sub,1}(t) and s_{sub,2}(t), includes at least one complete pitch period Pi. In the shown embodiment, the sub-segment s_{sub,2}(t) directly follows after the sub-segment s_{sub,1}(t). As shown in FIG. 2, for creating a modified segment sₒᵤₜ(t), the second sub-segment s_{sub,2}(t) is time-shifted towards the first sub-segment s_{sub,1}(t). The amount of the time shift dt is determined by the requirement, that in a resulting overlapping zone Lₒᵥ the correlation value for signals of the two sub-segments s_{sub,1}(t) and s_{sub,2}(t) is a maximum. For the overlapping zone Lₒᵥ, then, a signal sₒᵥ(t) is calculated. The calculation is based on a weighted average of the two sub-segments s_{sub,1}(t) and s_{sub,2}(t) in said overlapping zone. Hence, a smooth transition between the signal from the unmodified parts of the sub-segments and the signal sₒᵥ(t) from the overlapping zone is achieved. Different embodiments for calculating a weighted average signal from two overlapping signals are well known to those skilled in the art and thus are not described here in more detail. In the present described embodiment, the time-shift dt is exactly one pitch period Pi, because only then a maximum correlation for the two overlapping sub-segments s_{sub,1}(t) and s_{sub,2}(t) is achieved within the overlapping zone. With it, and with the creation of the signal sₒᵥ(t) as a weighted average, the modified-segment and hence the embedded watermark is less audible in the digital audio signal.

FIG. 3 shows a further possible embodiment of an input-segment sᵢₙ(t) from a digital audio signal. Here, the two sub-segments s_{sub,1}(t) and s_{sub,2}(t) are arranged such that a part of the input-signal sᵢₙ(t) is not included in one of the two sub-segments s_{sub,1}(t) and s_{sub,2}(t). For embedding the watermark, the two sub-segments s_{sub,1}(t) and s_{sub,2}(t) have to be rearranged on the time axis such that an overlapping zone, as shown in FIG. 4, is created. As already shown in the first embodiment, also in the present embodiment, the time-shift dt leads to a contraction of the output length Lₒᵤₜ of the modified segment sₒᵤₜ(t) compared to the input-length Lᵢₙ of the input-segment sᵢₙ(t). Therefore, for creating the modified segment sₒᵤₜ(t), the second sub-segment s_{sub,2}(t) is time-shifted towards the first sub-segment s_{sub,1}(t). The value of the time shift dt is also determined by the before described requirement, that in the overlapping zone Lₒᵥ, the correlation value of the two sub-segments s_{sub,1}(t) and s_{sub,2}(t) has to be a maximum. Finally, the signal sₒᵥ(t) is calculated for the overlapping zone Lₒᵥ, which is the weighted average of the parts from the two overlapping sub-segments s_{sub,1}(t) and s_{sub,2}(t) in said overlapping zone Lₒᵥ.

FIG. 5 shows a further embodiment according to the present invention. Contrary to the described embodiments before, here, the output-length Lₒᵤₜ of the modified-segment sₒᵤₜ(t) is extended, compared to the input-length Lᵢₙ of the input-segment sᵢₙ(t). Therefore, it is necessary that the input-segment sᵢₙ(t) is divided in such a manner, that the two sub-segments s_{sub,1}(t) and s_{sub,2}(t) are overlapping with more than one pitch period Pi. Then the requirement can be fulfilled, that after the time-shift dt the correlation value in the remaining overlapping zone Lₒᵥ reaches a maximum. For the modified-segment sₒᵤₜ(t), the resulting signal sₒᵥ(t) in the overlapping zone Lₒᵥ is created as already described in respect to the before described embodiments.

Now, with reference to FIG. 6, the method for detecting the embedded watermark in a received digital audio signal is described in more detail. A requirement for the present detection method is, that information from the original digital audio signal and the embedding method are known a-priori. This information is: the input-segment sᵢₙ(t), the modified segment sₒᵤₜ(t) and the start point t0 of the modified segment. Further, extension-segments ΔS₊(t), ΔS₋(t) are defined from the digital audio signal. The extension-segment ΔS₋(t) is a part of the digital audio signal before the input segment sᵢₙ(t), having the length ΔL₋. The extension-segment ΔS₊(t), with the length ΔL₊, is a part of the digital audio signal after the input segment sᵢₙ(t). Based on the input-segment sᵢₙ(t), the modified segment sₒᵤₜ(t) and the extension-signals ΔS₊(t), ΔS₋(t) several template-signals hm(t)=h1(t), h2(t), h3(t), . . . , hM(t) are generated. These template-signals are further used for the detection of the modified segment sₒᵤₜ(t) and hence the embedded watermarks within the received digital audio signal. Therefore a first template-signal h1(t) is generated from the input-segment sᵢₙ(t) and the extension-segments before ΔS₋(t) and after ΔS₊(t) that input-segment sᵢₙ(t). A second template-signal h2(t) is generated from the modified-segment sₒᵤₜ(t) and the extension-segments before ΔS₋(t) and after ΔS₊(t) that modified-segment sₒᵤₜ(t). The extension-segment ΔS₋(t) before the input-segment sᵢₙ(t) and the modified-segment sₒᵤₜ(t) is the identical signal segment and is directly taken from the original audio signal before embedding the watermark. The same applies to the extension segment ΔS₊(t) after the input-segment sᵢₙ(t) and the respective modified-segment sₒᵤₜ(t). Then, the received digital audio signal is compared with these first h1(t) and second h2(t) template-signals. Based on the comparison of the received audio signal with the first template-signal h1(t), a first correlation value c1 is created. A second correlation value c2 is created in the same way from the comparison of the received digital audio signal with the second template-signal h2(t). These correlation values, c1 and c2, then give an indication whether a modified-segment is embedded in the received digital audio signal. In more detail, if the second correlation value c2 is higher than the first one c1, it is assumed that a modified-segment sₒᵤₜ(t), and thus a watermark, is included in the received digital audio signal. Contrary, if the first correlation value c1 is higher, it is assumed that no watermark is included. Further, in FIG. 6, there is shown a third template signal h3(t). This can be used, if a watermark with a higher modulation level is embedded in the audio signal. In the present embodiment, the second template-signal h2(t) includes a contracted segment, whereas the third template h3(t).signal includes an expanded segment. Although the beforehand described embodiment is described with three template-signals, a person skilled in the art would recognize that much higher modulation levels can be achieved when the present invention is applied to several m=1, 2, 3, . . . , M input-segments s_{in,m}(t), where the output-length L_{out,m} from each of the respective modified-segments s_{out,m}(t) is different. Then, according to the number M of different modified-segments s_{out,m}(t), a corresponding number of different template signals hm(t) and correlation values cM for the detection are needed. With it more information can be included and detected in the modified digital audio signal. If for example M=4 different modified-segments are used, then in a group of N samples a 2-bit information (=1 d(M)) can be transmitted. In the easiest manner, different output-lengths L_{out,m} from each of the respective modified-segments s_{out,m}(t) can be achieved through the insertion and deletion of multiple pitches.

The main scope of the present invention, which has been described beforehand based on different embodiments, is to achieve a watermarking method, which has a higher resistance against synchronization attacks. Moreover the proposed method is also usable for added noise and other signal processing techniques, like filtering, which do not effect the synchronization. At least the same robustness as for spread-spectrum watermarks is expected. Furthermore, also compression techniques should not be problematic. This increased robustness is possible, because all these attacks usually do not change the number of pitches in the digital audio signal, where the proposed watermark is embedded. Furthermore, a simple jitter attack that inserts or deletes single sample, is not expected to be problematic. Even a slight shift still yields a high cross-correlation between the two waveforms, as long as the number of inserted or deleted samples is not too high. Even in that case, the proposed detection method can be repeated using different length of the modified segments. Considering pitch-shifting attacks, which are usually the most problematic attacks for watermarks, it is obvious that any scaling and shifting that is applied outside the template region should not affect the detection performance. If the input segment is positioned at t₀ and no modifications are made to any samples within the range (t₀−ΔL₋)<t<(t₀+ΔL₊+L_{OUT}), then the detection performance will not be affected. Only if an additional pitch-shift is performed within the template region by an attack, the correlation detector may be misled and may not detect the watermark correctly. However, if the length ΔL₋ and ΔL₊ from the extension segments ΔS₊(t), ΔS₋(t) can be kept reasonably short, e.g., corresponding to 40 ms, then a pitch-shifting attack has to be applied every 80 ms to remove the watermark with a high probability. Hence, the scheme can be designed to embed one watermark bit every N samples and provide robustness as long as additional pitch-shifts are inserted less frequently than every ((ΔL₋)+(ΔL₊)) sample. Assuming that (ΔL₋)+(ΔL₊)<<N, we can design the scheme such that the embedding is imperceptible but the attempt to remove the watermark results in audible distortions.

1. A method for embedding a watermark in a digital audio signal, the digital audio signal, which includes several pitch periods, is divided into groups of N samples, the method comprising the steps of:
selecting from one of the groups of N samples an input-segment with an input-length,
dividing the input-segment into at least two sub-segments, each sub-segment having a length of at least one pitch period,
creating a modified-segment with an output-length, wherein at least one of the sub-segments is time-shifted such that in an overlapping zone (Lₒᵥ) a correlation value of the two sub-segments is a maximum, and wherein the signal in the overlapping zone is a weighted average of the two sub-segments in said overlapping zone.

2. The method according to claim 1, wherein the output-length is contracted compared to the input-length.

3. The method according to claim 1, wherein
the input-segment is divided such that the at least two sub-segments are overlapping with at least two pitch periods, and
the output-length is extended compared to the input-length.

4. The method according to claim 1, wherein the time-shift from said at least one of the sub-segments is equal to one period.

5. The method according to claim 1, wherein the time-shift from said at least one of the sub-segments is equal to a multiple number of the pitch periods.

6. The method according to claim 1, wherein the input-segment is selected at a position in the group of N samples, where consecutive pitch periods are similar.

7. The method according to claim 1, wherein the input-segment is selected from the mid of the group of N samples.

8. The method according to claim 1, wherein the input-segment is selected depending on a pre-defined secret key.

9. The method according to claim 1 wherein the steps are repeated for several input-segments wherein the output-length from each of the respective modified-segments is different.

10. A method for detecting a watermark in a received digital audio signal, wherein the received digital audio signal may includes at least one modified-segment said modified segment having modified an input segment, the method comprising the steps of:
receiving for said at least one modified-segment information associated with the input-segment the modified-segment, extension-segments and a start point of that modified-segment,
generating a first template-signal, which is the input-segment with the extension-segments before and after input-segment,
generating a second template-signal, which is the modified-segment with the extension-segments before and after the modified-segment.
creating a first M and a second correlation value by comparing the first and second template-signal with the received digital audio signal,
and assuming that a watermark is included, if the second correlation value is higher than the first correlation value.

11. The method according to claim 10, wherein
the generation of said second template-signal is divided into the steps of:
generating the second template-signal, which is a contracted segment with the extension segments before and after the modified-segment, and
generating a third template-signal, which is an expanded segment with the extension segments before and after the modified-segment;
then the first, the second and a third (correlation value are created, wherein the third correlation value is created by comparing the third template-signal with the received digital audio signal;
and then it is assumed that a contracted watermark is included, if the second correlation value is higher than the first and third correlation value or that an extended watermark is included if the third correlation value is higher than the first and second correlation value.

12. The method according to claim 10, characterized in that the steps are repeated for several input-segments wherein the output-length from each of the respective modified-segments is different.

13. The method according to claim 10, wherein
the length of the extension-segments are in the range of 10 ms to 40 ms.

14. The method according to claim 10, wherein
the length ΔL₋ and ΔL₊ fulfill the condition ΔL₋+ΔL₊<<N, where N is the number of samples in a group.
